(19) United States
(12) Patent Application Publication
(10) Pub. No.: US 2024/0306163 A1
(43) Pub. Date: Sep. 12, 2024

(54) METHOD AND APPARATUS FOR DETERMINING SCHEDULING INFORMATION BY A USER EQUIPMENT (UE) FOR ANOTHER UE

(71) Applicant: QUALCOMM Incorporated, San Diego, CA (US)

(72) Inventors: Huilin Xu, Temecula, CA (US); Shuanshuan Wu, San Diego, CA (US); Peng Cheng, Beijing (CN); Kapil Gulati, Belle Mead, NJ (US)

(21) Appl. No.: 18/261,448

(22) PCT Filed: Mar. 12, 2021
(86) PCT No.: PCT/CN2021/080362

§ 371 Date: Jul. 13, 2023

(51) Int. Cl. H04W 72/25; H04W 28/26; H04W 72/0457; H04W 72/12

(52) U.S. Cl. CPC H04W 72/25; H04W 28/26; H04W 72/0457; H04W 72/12

(57) ABSTRACT

A method of wireless communication performed by a first user equipment (UE) includes determining scheduling information that is associated with a sidelink communication associated with a second UE. The method further includes transmitting, via a sidelink control channel, a sidelink control information (SCI) message to the second UE indicating the scheduling information for use in connection with the sidelink communication.

### TECHNICAL FIELD

Aspects of the present disclosure relate generally to wireless communication systems, and more particularly, to wireless communication systems that use scheduling to transmit and receive signals.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In some aspects of the disclosure, a method of wireless communication performed by a first user equipment (UE) includes determining scheduling information that is associated with a sidelink communication associated with a second UE. The method further includes transmitting, via a sidelink control channel, a sidelink control information (SCI) message to the second UE indicating the scheduling information for use in connection with the sidelink communication.

In some other aspects of the disclosure, an apparatus for wireless communication includes a memory and a processor coupled to the memory. The memory is configured to determine, at a first UE, scheduling information that is associated with a sidelink communication associated with a second UE and to initiate transmission, via a sidelink control channel, of an SCI message to the second UE indicating the scheduling information for use in connection with the sidelink communication.

In some other aspects of the disclosure, a non-transitory computer-readable medium stores instructions executable by a processor to initiate, perform, or control operations. The operations include determining, at a first UE, scheduling information that is associated with a sidelink communication associated with a second UE. The operations further include transmitting, via a sidelink control channel, an SCI message to the second UE indicating the scheduling information for use in connection with the sidelink communication.

In some other aspects of the disclosure, an apparatus for wireless communication includes means for determining, at a first UE, scheduling information that is associated with a sidelink communication associated with a second UE. The apparatus further includes means for transmitting, via a sidelink control channel, an SCI message to the second UE indicating the scheduling information for use in connection with the sidelink communication.

### BRIEF DESCRIPTION OF THE DRAWINGS

FIG. 1 is a block diagram illustrating an example of a wireless communication system according to some aspects of the disclosure.

FIG. 2 is a block diagram illustrating examples of a base station and a user equipment (UE) according to some aspects of the disclosure.

FIG. 3 is a block diagram illustrating an example of a wireless communication system according to some aspects of the disclosure.

FIG. 4 is a block diagram illustrating an example of resources that may be associated with a wireless communication system according to some aspects of the disclosure.

FIG. 5 is a block diagram illustrating an example of a sidelink control information (SCI) transmission schedule according to some aspects of the disclosure.

FIG. 6 is a block diagram illustrating aspects of an example of a resource reservation operation according to some aspects of the disclosure.

FIG. 7 is a ladder diagram illustrating examples of operations that may be performed by a first UE and a second UE according to some aspects of the disclosure.

FIG. 8 is a flow diagram illustrating an example of a method of operation of a UE according to some aspects of the disclosure.

FIG. 9 is a flow diagram illustrating another example of a method of operation of a UE according to some aspects of the disclosure.

FIG. 10 is a block diagram of an example of a UE according to some aspects of the disclosure.

### DETAILED DESCRIPTION

Some wireless communication protocols may specify parameters for different categories (or “tiers”) of devices. For example, a wireless communication protocol may specify a category of cost-effective or reduced capability (RedCap) devices. The RedCap devices may be associated with one or more parameters (such as throughput, bandwidth, latency, or reliability, efficiency, or cost) that are less than (or “relaxed) as compared to another category of devices, such as “premium” devices. Some examples of RedCap devices may include wearable devices (such as a smart watch or a medical device), Internet-of-Things (IoT) devices, consumer IoT (CIot) devices, industrial wireless sensor network (IWSN) devices, image sensors (e.g., surveillance cameras), or “low-end” smart phones, as illustrative examples.

In some cases, operations performed by a RedCap device may incur a relatively high amount of power consumption by the RedCap device. For example, due to the “relaxed” parameters associated with the RedCap category of devices, the RedCap device may include relatively cost-effective and low-complexity circuitry and components. If certain processing and other operations performed by the RedCap device to communicate within a wireless communication system are relatively complex, then the operations may be relatively taxing for the circuitry and components, resulting in a relatively high amount of power consumption by the RedCap device.

In some aspects of the disclosure, a first user equipment (UE) (such as a “premium” UE) may perform one or more operations on behalf of a second UE (such as a RedCap UE). For example, the second UE may “off-load” certain operations to the first UE to reduce power consumption by the second UE, to take advantage of an enhanced processing or communication capability of the first UE, or both. To illustrate, in some examples, the first UE determines scheduling information on behalf of the second UE and indicates the scheduling information to the second UE using a sidelink control information (SCI) message. In some examples, the scheduling information may include a wakeup parameter (such as a wakeup schedule) associated with the second UE or a bandwidth part (BWP) switching parameter (such as a BWP switching schedule) associated with the second UE.

In an illustrative example, the first UE may perform a resource reservation operation on behalf of the second UE. Performing the resource reservation operation may include sensing one or more wireless communication channels (e.g., to scan for reservation signals from other devices) and transmitting a reservation signal in response to determining availability of resources of the one or more wireless communication channels. Because such channel sensing and reservation operations may be associated with a relatively large amount of power consumption, and because the first UE may be associated with higher-complexity or higher-cost components or circuitry relative to the first UE, offloading the resource reservation operation from the second UE to the first UE may reduce power consumption by the second UE.

Further, in some cases, offloading the resource reservation operation from the second UE to the first UE may improve results of the resource reservation operation (as compared to performance of the resource reservation operation by the second UE). For example, in some implementations, the second UE may be associated with a communication bandwidth that is less than a communication bandwidth of the first UE, such as if the second UE is a narrowband RedCap UE. In this case, the second UE may be unable to detect one or more reservation signals transmitted at frequencies outside the communication bandwidth of the second UE. As a result, offloading the resource reservation operation from the second UE to the first UE may reduce or avoid instances of signal collisions that may occur if the second UE fails to detect a reservation signal while performing the resource reservation operation.

To further illustrate, some aspects of the disclosure may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km\ddot{ }2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., 99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km\ddot{ }2), extreme data rates (e.g., multi-Gbps rate, 100-Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 khz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

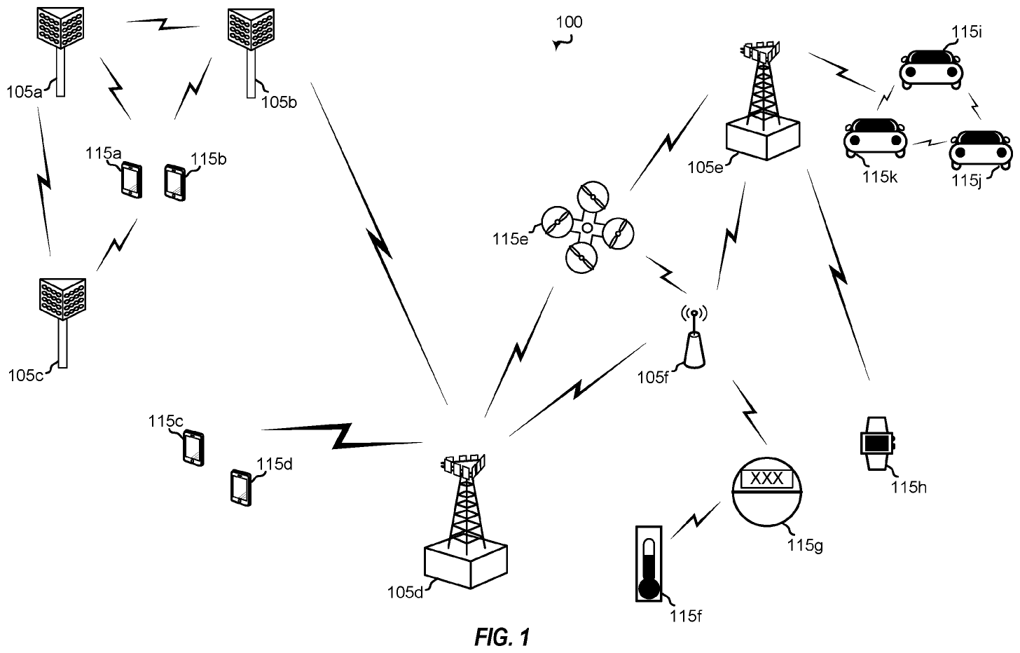

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such as UE 115c, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional I network efficiency through dynamic, low-latency TDD communications or low-latency FDD communications, such as in a vehicle-to-vehicle (V2V) mesh network between UEs 115i-115k communicating with macro base station 105e.

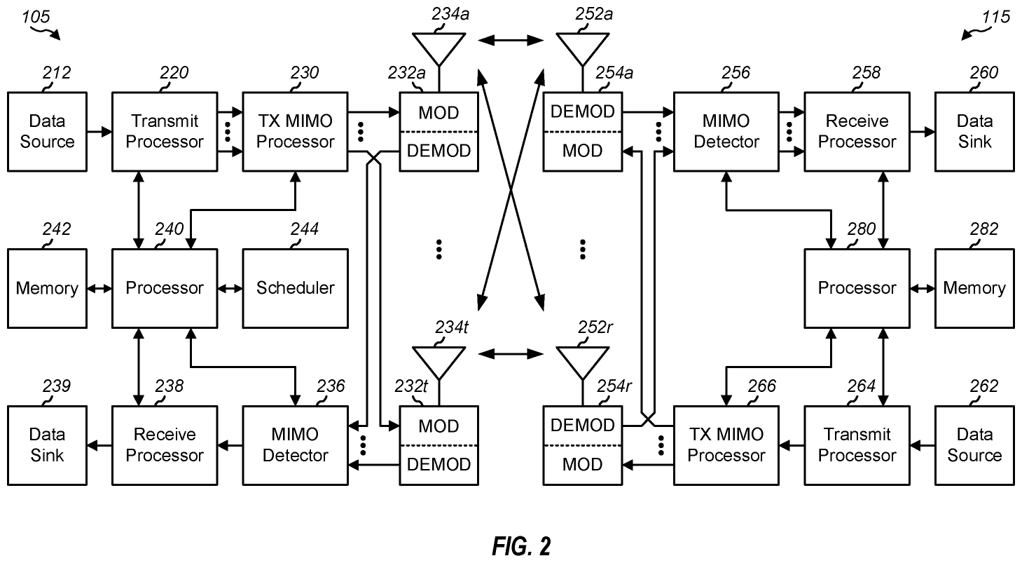

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from processor 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to processor 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to processor 240.

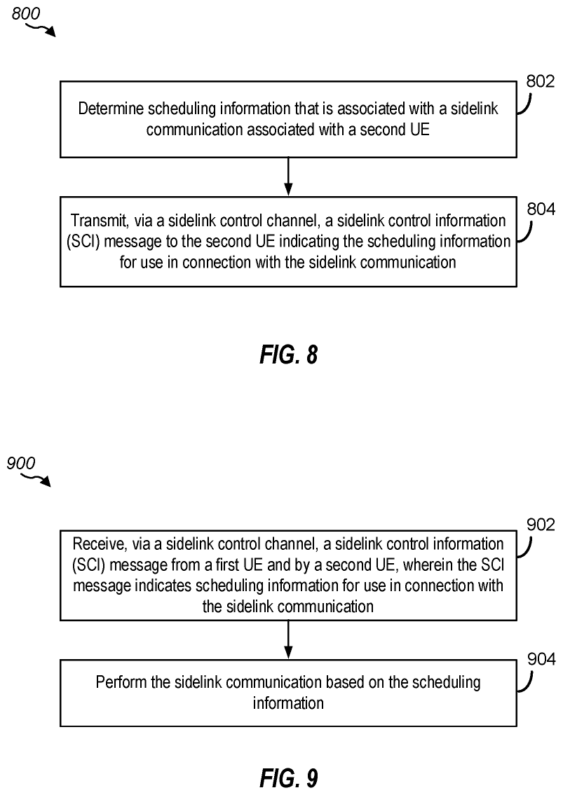

Processors 240 and 280 may direct the operation at base station 105 and UE 115, respectively. Processor 240 or other processors and modules at base station 105 or processor 280 or other processors and modules at UE 115 may perform or direct the execution of various processes for the techniques described herein, such as to perform or direct the execution illustrated in FIGS. 8 and 9, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

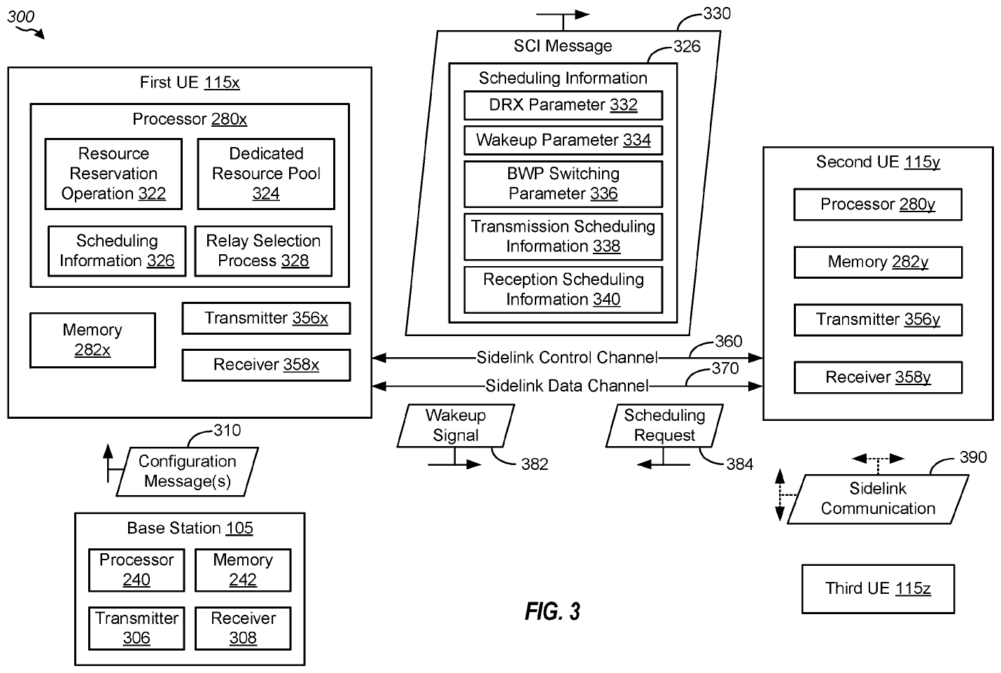

FIG. 3 is a block diagram illustrating an example of a wireless communication system 300 according to some aspects of the disclosure. The wireless communication system 300 may include one or more base stations, such as the base station 105. The wireless communication system may further include one or more UEs, such as a first UE 115x, a second UE 115y, and a third UE 115z.

The example of FIG. 3 illustrates that the base station 105 may include one or more processors (such as the processor 240) and may include the memory 242. The base station 105 may further include a transmitter 306 and a receiver 308. The processor 240 may be coupled to the memory 242, to the transmitter 306, and to the receiver 308. In some examples, the transmitter 306 and the receiver 308 include one or more components described with reference to FIG. 2, such as one or more of the modulator/demodulators 232a-t, the MIMO detector 236, the receive processor 238, the transmit processor 220, or the TX MIMO processor 230.

The transmitter 306 may transmit reference signals, synchronization signals, control information, and data to one or more other devices, and the receiver 308 may receive reference signals, control information, and data from one or more other devices. For example, the transmitter 306 may transmit signaling, control information, and data to the UE 115, and the receiver 308 may receive signaling, control information, and data from the UE 115. In some implementations, the transmitter 306 and the receiver 308 may be integrated in one or more transceivers of the base station 105.

FIG. 3 also illustrates that each of the UEs 115x, 115y, and 115z may include one or more processors (such as the processor 280), a memory (such as the memory 282), a transmitter, and receiver. For example, the first UE 115x may include a processor 280x, a memory 282x, a transmitter 356x, and a receiver 358x. As another example, the second UE 115y may include a processor 280y, a memory 282y, a transmitter 356y, and a receiver 358y. In some examples, the transmitters 356x and 356y and the receivers 358x and 358y may include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 356x and the receiver 358x may be integrated in one or more transceivers of the first UE 115x, and the transmitter 356y and the receiver 358y may be integrated in one or more transceivers of the second UE 115y.

The transmitters 356x and 356y may transmit reference signals, synchronization signals, control information, and data to one or more other devices, and the receiver 358 may receive reference signals, control information, and data from one or more other devices. For example, in some implementations, the transmitter 356x may transmit signaling, control information, and data to one or more of the base station 105, the second UE 115y, and the third UE 115z, and the receiver 358x may receive signaling, control information, and data from one or more of the base station 105, the second UE 115y, and the third UE 115z. As another example, in some implementations, the transmitter 356y may transmit signaling, control information, and data to one or more of the base station 105, the first UE 115x, and the third CE 115z, and the receiver 358y may receive signaling, control information, and data from one or more of the base station 105, the first UE 115x, and the third UE 115z.

In some implementations, one or more of the transmitter 306, the receiver 308, the transmitter 356, or the receiver 358 may include an antenna array. The antenna array may include multiple antenna elements that perform wireless communications with other devices. In some implementations, the antenna array may perform wireless communications using different beams, also referred to as antenna beams. The beams may include transmit beams and receive beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. In some implementations, one or more sets of antenna elements of the antenna array may be configured to concurrently generate multiple beams, for example using multiple RF chains. A set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, the first UE 115x is associated with a first capability, and one or both of the second UE 115y and the third UE 115z are associated with a second capability that is less than the first capability. For example, the first UE 115x may correspond to a “premium” device, and one or both of the second UE 115y and the third UE 115z may correspond to a reduced capability (RedCap) device. To illustrate, the first UE 115x may correspond to a smart phone, and one or both of the second UE 115y and the third UE 115z may correspond to a wearable device (such as a smart watch or a medical device) that communicates with the smart phone, as illustrative examples. In some other implementations, one or more of the UEs 115x, 115y, and 115z may correspond to Internet-of-Things (IoT) devices, consumer IoT (Clot) devices, industrial wireless sensor network (IWSN) devices, image sensors (e.g., surveillance cameras), as illustrative examples.

In some implementations, wireless communication system 300 operates in accordance with a 5G NR network. For example, the wireless communication system 300 may include multiple 5G-capable UEs 115 and multiple 5G-capable base stations 105, such as UEs and base stations configured to operate in accordance with a 5G NR network protocol such as that defined by the 3GPP. Depending on the particular example, aspects described herein may be used in connection with a mode one (“Mode 1”) sidelink resource allocation mode, a mode two (“Mode 2”) sidelink resource allocation mode, one or more other modes, or a combination thereof. As used herein, a mode one sidelink resource allocation operation may correspond to a centralized mode in which the base station 105 determines resource allocations for wireless communications by the UEs 115y, 115z. As used herein, a mode two sidelink resource allocation operation may correspond to a distributed mode in which the UEs 115y, 115z are enabled to autonomously determine resource allocations for the wireless communications.

During operation, the first UE 115x may communicate with one or both of the second UE 115y and the third UE 115z via one or more sidelink channels. Examples of a sidelink channel include a sidelink control channel 360 and a sidelink data channel 370. In some implementations, the sidelink control channel 360 may include or correspond to a physical sidelink control channel (PSCCH), and the sidelink data channel may include or correspond to a physical sidelink shared channel (PSSCH). The sidelink control channel 360 may optionally include a physical sidelink feedback channel (PSFCH).

In some aspects of the disclosure, the first UE 115x may perform one or more operations on behalf of one or more other UEs (such as the second UE 115y), which may reduce power consumption by the one or more other UEs. To illustrate, the first UE 115x may determine scheduling information 326 for a sidelink communication 390 associated with the second UE 115y, such as by performing a resource reservation operation 322 on behalf of the second UE 115y. For example, determining the scheduling information 326 may include receiving (e.g., from the base station 105 in connection with a mode one sidelink resource allocation operation) one or more configuration messages 310 indicating resources associated with the sidelink communication 390, and the scheduling information 326 may indicate the resources.

Alternatively or in addition, determining the scheduling information 326 may include performing a resource reservation operation 322. Performing the resource reservation operation 322 may include scanning (e.g., in connection with a mode two sidelink resource allocation operation) one or more wireless communication channels (such as the sidelink data channel 370) for reservation signals from one or more devices. The first UE 115x may determine availability of resources for the sidelink communication 390 based on a result of the resource reservation operation 322. To illustrate if the first UE 115x fails to detect a reservation signal during the resource reservation operation 322, the first UE 115x may transmit a reservation signal indicating reservation of resources corresponding to the one or more wireless communication channels, and the scheduling information 326 may indicate the resources. In some other examples, if the first UE 115x detects one or more reservation signals during the resource reservation operation 322, the first UE 115x may terminate the resource reservation operation 322 and may reinitiate the resource reservation operation 322 at a later time.

In response to determining the scheduling information 326, the first UE 115x may transmit a sidelink control (SCI) message 330 to the second UE 115y. In some examples, the first UE 115x transmits the SCI message 330 via the sidelink control channel 360. The SCI message 330 may indicate the scheduling information 326 for use in connection with the sidelink communication 390. In an illustrative non-limiting example, the scheduling information 326 may indicate one or more of a discontinuous reception (DRX) parameter 332 associated with the second UE 115y, a wakeup parameter 334 associated with the second UE 115y, a bandwidth part (BWP) switching parameter 336 associated with the second UE 115y, transmission scheduling information 338 associated with the second UE 115y, or reception scheduling information 340 associated with the second UE 115y.

In some aspects of the disclosure, the first UE 115x transmits the SCI message 330 using resources included in a dedicated resource pool 324 for SCI communication between the first UE 115x and one or more other UEs, such as the second UE 115y. Resources included in the dedicated resource pool 324 may be distinct from resources included in a unicast resource pool, resources included in a groupcast resource pool, and resources included in a broadcast resource pool.

In some examples, the dedicated resource pool 324 is configured by the base station 105. In such examples, a configuration message of the one or more configuration messages 310 may indicate the dedicated resource pool 324 to the first UE 115x. Further, in some implementations, the base station 105 may activate and deactivate the dedicated resource pool 324 (or individual resources of the dedicated resource pool 324) after configuration of the dedicated resource pool 324.

In some other examples, the first UE 115x may determine the dedicated resource pool 324 (e.g., without receiving an explicit indication of the dedicated resource pool 324 from the base station 105). For example, the first UE 115x may determine the dedicated resource pool based at least in part on one or more of a communication bandwidth associated with the second UE 115y or a common resource pool configuration message broadcast by the base station 105. The common resource pool configuration message may indicate a common resource pool for sidelink communications by UEs, and the first UE 115x may select (or “carve out”) the dedicated resource pool 324 from resources of the common resource pool.

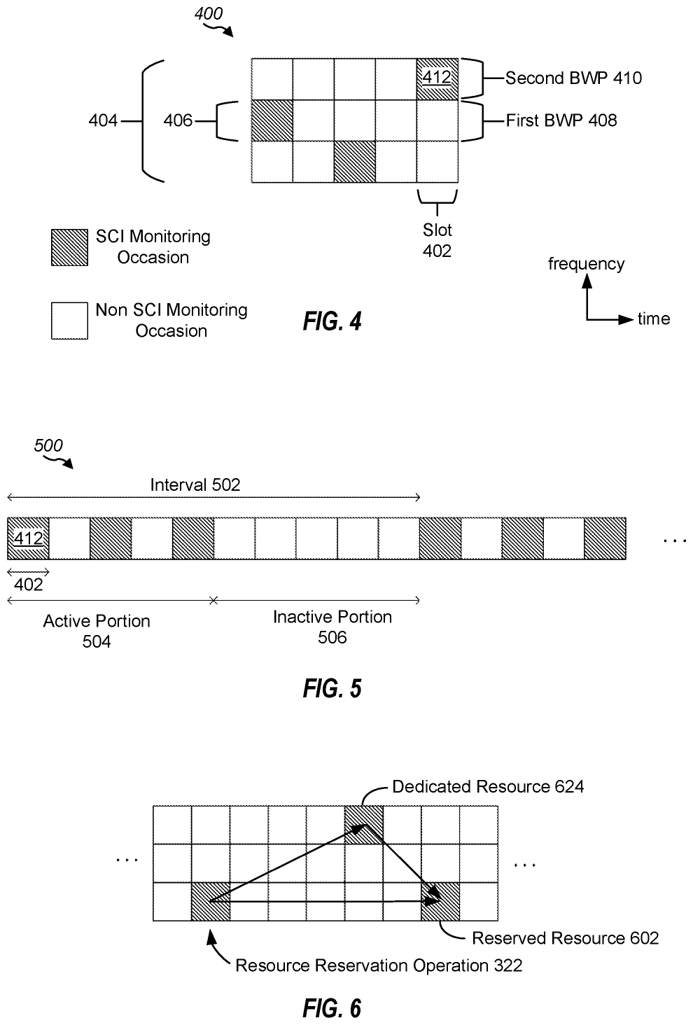

To further illustrate, FIG. 4 is a block diagram illustrating an example of resources 400 that may be associated with a wireless communication system (such as the wireless communication system 300 of FIG. 3) according to some aspects of the disclosure. In some examples, the resources 400 correspond to the common resource pool described with reference to FIG. 3. In FIG. 4, the abscissa may indicate time (e.g., slots, such as a representative slot 402), and the ordinate may represent frequency.

In some implementations, the first UE 115x is associated with a first bandwidth 404 (e.g., a first supported communication bandwidth, such as a “maximum” supported communication bandwidth or a configured communication bandwidth of the first UE 115x), and the second UE 115y is associated with a second bandwidth 406 (e.g., a second supported communication bandwidth, such as a “maximum” supported communication bandwidth or a configured communication bandwidth of the second UE 115y) that is different than (e.g., less than) the first bandwidth 404. To illustrate, the second UE 115y may correspond to a RedCap UE having a reduced communication bandwidth relative to the first CE 115x. In some examples, frequency resources of the dedicated resource pool 324 of FIG. 3 are based on the second bandwidth 406. For example, the frequency resources of the dedicated resource pool 324 may correspond to or may be included in the second bandwidth 406.

FIG. 4 illustrates examples of a first BWP 408 and a second BWP 410 that may be used by the second UE 115y. For example, the second UE 115y may tune the transmitter 356y (or the receiver 358y) from transmitting (or receiving) signals using the first BWP 408 to transmitting (or receiving) signals based on the second BWP 410 using the BWP switching parameter 336. In this example, the second bandwidth 406 of the second UE 115y may be changed (e.g., reconfigured) from the first BWP 408 to the second BWP 410, such as if the second bandwidth 406 is changed dynamically based on a frequency hopping pattern that uses the first BWP 408 and the second BWP 410. In some implementations, the BWP switching parameter 336 indicates a BWP switching schedule, and the second UE 115y switches between the first BWP 408 and the second BWP 410 based on the BWP switching schedule. To further illustrate, the first BWP 408 may be associated with a first bandwidth, and the second BWP may be associated with a second bandwidth that is greater than (e.g., wider than) the first bandwidth. In some examples, to enable an increase (or decrease) of a data rate associated with the sidelink communication 390, the first UE 115x may indicate (e.g., via the BWP switching parameter 336) that the second UE 115y is perform a BWP switching operation from the first BWP 408 to the second BWP 410 (or vice versa) for the sidelink communication 390.

FIG. 4 also depicts that the resources 400 may be associated with SCI monitoring occasions (illustrated with crosshatching) and non SCI monitoring occasions (illustrated without crosshatching). During SCI monitoring occasions associated with frequency resources within the second bandwidth 406, the second UE 115y may monitor the sidelink control channel 360 for SCI messages, such as the SCI message 330. For example, the first UE 115x may transmit the SCI message 330 during an SCI monitoring occasion 412. The SCI monitoring occasion 412 may be associated with time resources and frequency resources that are dedicated to the first UE 115x and the second UE 115y. For example, the time resources may correspond to the slot 402, and the frequency resources may correspond to the second bandwidth 406.

In some implementations, frequency resources of the resources 400 are associated with a frequency hopping pattern. For example, in FIG. 4, SCI monitoring occasions may be associated with different frequencies that are based on the frequency hopping pattern. The frequency hopping pattern may be associated with a frequency range that exceeds the second bandwidth 406 associated with the second UE 115y. For example, the frequency range of the frequency hopping pattern may correspond to the first bandwidth 404 associated with the first UE 115x. In some examples, time resources associated with the SCI monitoring occasion 412 may correspond to a subset of the dedicated resource pool 324. For example, the dedicated resource pool 324 may include time resources corresponding to slots other than the slot 402.

FIG. 5 is a block diagram illustrating an example of an SCI transmission schedule 500 according to some aspects of the disclosure. In some examples, the first UE 115x transmits an indication of the SCI transmission schedule 500 to the second UE 115y via the sidelink data channel 370. The second UE 115y may monitor the sidelink control channel 360 based on the SCI transmission schedule 500. For example, the first UE 115x may transmit SCI messages (such as the SCI message 330) based on the SCI transmission schedule 500, and the second UE 115y may monitor for and receive the SCI messages (such as the SCI message 330) based on the SCI transmission schedule 500.

The SCI transmission schedule 500 may indicate a first plurality of slots during which the second UE 115y is to monitor the sidelink control channel 360 for SCI messages (such as the SCI message 330). For example, the first plurality of slots may be included in or may correspond to an active portion 504 of the SCI transmission schedule 500. In some implementations, the slots of the active portion 504 may correspond to “candidate” slots for SCI transmissions. In this case, some, all, or none of the slots of the active portion 504 may be used for SCI transmissions.

The SCI transmission schedule 500 may further indicate a second plurality of slots during which the second UE 115y is to avoid monitoring the sidelink control channel 360 for the SCI messages. For example, the second plurality of slots may be included in an inactive portion 506. In some implementations, the slots of the inactive portion 506 may correspond to “ineligible” slots that are ineligible for SCI transmissions. The active portion 504 and the inactive portion 506 may be included in an interval 502 (e.g., a period of the SCI transmission schedule 500).

FIG. 6 is a block diagram illustrating aspects of an example of a resource reservation operation (such as the resource reservation operation 322 of FIG. 3) according to some aspects of the disclosure. During the resource reservation operation 322, the first UE 115x may sense one or more wireless communication channels to determine whether the one or more wireless communication channels are available. In response to a result of the resource reservation operation 322 indicating availability of the one or more wireless communication channels, the first UE 115x may reserve one or more resources (such as a reserved resource 602). The first UE 115x may transmit the SCI message 330 to the second UE 115y using a dedicated resource 624 to indicate the reserved resource 602 (e.g., via the scheduling information 326). The dedicated resource 624 may be included in the dedicated resource pool 324 and may be associated with the sidelink control channel 360. The second UE 115y may use the reserved resource 602 to perform the sidelink communication 390.

Alternatively or in addition, in some implementations, the second UE 115y may operate according to a sleep mode of operation or a low-power mode of operation until instructed by the first UE 115x to initiate another mode of operation, such as a higher-power mode of operation. To illustrate, referring again to FIG. 3, the first UE 115x may transmit a wakeup signal 382 to the second UE 115y indicating that the second UE 115y is to transition from a first mode of operation to a second mode of operation to monitor for one or more SCI messages (such as the SCI message 330) during the active portion 504 of the SCI transmission schedule 500. In some implementations, the first mode is associated with a first power consumption by the second UE 115y, the second mode is associated with a second power consumption by the second UE 115y, and the second power consumption is greater than the first power consumption.

In some implementations, the first UE 115x transmits the wakeup signal 382 prior to the active portion 504 to indicate whether the second UE 115y is to monitor for the SCI message 330 during the active portion 504. Transmitting the wakeup signal 382 prior to the active portion 504 may give the second UE 115y time to adjust from the first mode to the second mode prior to the active portion 504.

In some other implementations, the first UE 115x transmits the wakeup signal 382 during the active portion 504, and the wakeup signal 382 indicates whether the second UE 115y is to monitor for the SCI message 330 during one or more particular slots of the active portion 504. As an example, the wakeup signal 382 may indicate that the second UE 115y is to monitor for the SCI message 330 during the slot 402.

The first UE 115x may perform an association process (such as a “pairing” process) to detect and establish communications with one or both of the second UE 115y and the third UE 115z. In some examples, a configuration message (such as a radio resource control (RRC) configuration message) of the one or more configuration messages 310 indicates that the first UE 115x is associated with one or more UEs, such as the second UE 115y. To illustrate, in some implementations, each of the UEs 115x, 115y, and 115z may be in cellular communication with the base station 105, and the base station 105 may detect, based on the cellular communications, the UEs 115x, 115y, and 115z satisfy one or more matching criteria (such as that the UEs 115x, 115y, and 115z are within a particular communication range of one another). The first UE 115x may receive the configuration message and may transmit the SCI message 330 based on receiving the configuration message.

In some other examples, the first UE 115x may detect one or both of the UEs 115y, 115z by “reusing” a relay selection process or a relay reselection process (hereinafter referred to as a relay selection process 328). To illustrate, the UEs 115x, 115y, and 115z may operate according to a wireless communication protocol (such as a 5G NR wireless communication protocol) that specifies the relay selection process 328. Performing the relay selection process 328 may include designating the first UE 115x as a relay device that relays data or other signals from the base station 105 to the UEs 115y and 115z, from the UEs 115y and 115z to the base station 105, or both. To further illustrate, the first UE 115x may transmit the SCI message 330 to the second UE 115y based on detecting the second UE 115y using the relay selection process 328.

In some other examples, the UEs 115x, 115y, and 115z may communicate without using an association process. To illustrate, the first UE 115x may “blindly” broadcast the SCI message 330 to indicate presence of the first UE 115x to one or more UEs within communication range of the first UE 115x, such as the second UE 115y.

In some implementations, one or more signals described herein may be transmitted using a low-power mode of operation. For example, during an association process, the first UE 115x may transmit a broadcast message using a low-power mode. The broadcast message may indicate one or more identifiers of the first UE 115x. By using the low-power mode, one or more UEs proximate to the first UE 115x (such as the UEs 115y, 115z) may be enabled to receive the broadcast message, while one or more other UEs (such as UEs that are not to be paired with the first UE 115x) may be unable to receive the broadcast message. As an example, the first UE 115x may correspond to a smart phone, and the UEs 115y and 115z may correspond to wearable devices to be paired with the first UE 115x. In this case, the UEs 115x, 115y, and 115z may be in relatively close proximity to one another during the pairing process, and the broadcast message may be transmitted using a relatively low power based on the relatively close proximity.

In some implementations, the second UE 115y may transmit a scheduling request 384 for resources associated with the sidelink communication 390. The first UE 115x may receive the scheduling request 384 and may transmit the SCI message 330 to the second UE 115y based on the scheduling request 384.

After receiving the SCI message 330, the second UE 115y may perform the sidelink communication 390 based on the scheduling information 326 (such as using resources indicated by the scheduling information 326). In some examples, the SCI message 330 schedules the sidelink communication 390 for other UEs, such as the UEs 115y, 115z. In this case, the sidelink communication 390 may include transmitting data by one of the second UE 115y and the third UE 115z to the other of the second UE 115y and the third UE 115z. To facilitate the sidelink communication 390 between the UEs 115y, 115z, in some implementations, the first UE 115x transmits the SCI message 330 to both the UEs 115y, 115z. For example, the first UE 115x may transmit the SCI message 330 to both the UEs 115y, 115z, and the SCI message 330 may identify the second UE 115y as a transmitter of the sidelink communication 390 and may further identify the third UE 115z as a receiver of the sidelink communication 390. In some other implementations, the first UE 115x may transmit the SCI message 330 to one of the UEs 115y, 115z (without transmitting the SCI message 330 to the other of the UEs 115y, 115z). For example, the first UE 115x may transmit a first SCI message (such as the SCI message 330) to the second UE 115y that identifies the second UE 115y as a transmitter of the sidelink communication 390 and may transmit a second SCI message to the third UE 115z that includes a wakeup signal prior to performing the sidelink communication 390.

In some other examples, the SCI message 330 schedules the sidelink communication 390 for the first UE 115x and one or more other UEs, such as the second UE 115y. In this case, the sidelink communication 390 may include transmitting data by one of the first UE 115x and the second UE 115y to the other of the first UE 115x and the second UE 115y. To illustrate, the sidelink communication 390 may include relaying, by the first UE 115x, downlink data from the base station 105 to the second UE 115y and may further include relaying uplink data from the second UE 115y to the base station 105. In this example, the first UE 115x may function as a data relay for both uplink and downlink communication of the second UE 115y. In some other examples, the first UE 115x may function as a data relay for uplink communications of the second UE 115y (and without functioning as a data relay for downlink communications of the second UE 115y). In this case, power consumption and hardware complexity of the second UE 115y may be reduced by using the first UE 115y as an uplink relay while also enabling the second UE 115y to communicate directly with the base station 105 for downlink communications. To further illustrate, the sidelink communication 390 may include relaying, by the first UE 115x, uplink data from the second UE 115y to the base station 105, and the second UE 115y may receive downlink data directly from the base station 105.

In some implementations, the first UE 115x may perform one or more processing operations based on data received from the second UE 115y and prior to relaying the data to the base station 105. To illustrate, the second UE 115y may include an image sensor (such as a surveillance camera), and the data may include image data captured by the image sensor. In some technologies, the second UE 115y may conserve power by offloading certain image processing operations to the first UE 115x, such as one or more of encoding the image data, compressing the image data, encrypting the image data, or transcoding the image data (e.g., from a first file format to a second file format). In this case, the second UE 115y may provide “raw,” unprocessed, or semi-processed image data to the first UE 115x, and the first UE 115x may perform the image processing operations prior to relaying the data to the base station 105.

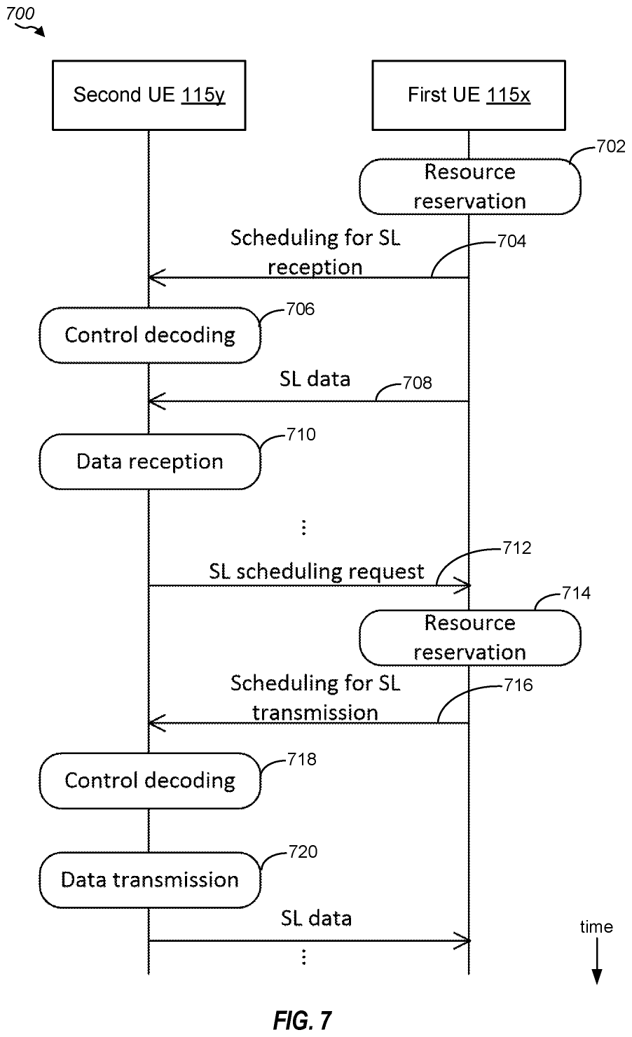

To further illustrate, FIG. 7 is a ladder diagram illustrating examples of operations 700 that may be performed by a first UE (such as the first UE 115x) and a second UE (such as the second UE 115y) according to some aspects of the disclosure. The operations 700 may include performing a resource reservation operation, at 702. For example, the resource reservation operation may correspond to the resource reservation operation 322 of FIG. 3.

The operations 700 may further include scheduling a sidelink reception operation, at 704. For example, scheduling the sidelink reception operation may include transmitting the SCI message 330, and the scheduling information 326 may indicate the sidelink reception operation.

The operations 700 may further include performing control decoding, at 706. For example, the second UE 115y may decode the SCI message 330 to determine that the second UE 115y is scheduled to receive sidelink data in connection with the sidelink reception operation.

The operations 700 may further include transmitting the sidelink data in connection with the sidelink reception operation, at 708. For example, the first UE 115x may transmit the sidelink data using resources that indicated by the scheduling information 326.

The operations 700 may further include receiving the sidelink data in connection with the sidelink reception operation, at 710. For example, the second UE 115y may receive the sidelink data using resources indicated by the scheduling information 326.

The operations 700 may further include transmitting a sidelink scheduling request, at 712. For example, the second UE 115y may transmit the scheduling request 384 to the first UE 115x.

The operations 700 may further include performing a resource reservation operation based on the sidelink scheduling request, at 714. For example, the resource reservation operation may correspond to the resource reservation operation 322 of FIG. 3 or to another resource reservation operation that is performed in response to the sidelink scheduling request.

The operations 700 may further include scheduling a sidelink transmission operation, at 716. For example, scheduling the sidelink transmission operation may include transmitting the SCI message 330 (or another SCI message), and the scheduling information 326 (or other scheduling information) may indicate the sidelink transmission operation.

The operations 700 may further include performing control decoding, at 718. For example, the second UE 115y may decode the SCI message 330 (or other SCI message) to determine that the second UE 115y is scheduled to transmit sidelink data in connection with the sidelink transmission operation.

The operations 700 may further include transmitting the sidelink data in connection with the sidelink transmission operation, at 720. For example, the second UE 115y may transmit the sidelink data using resources indicated by the scheduling information 326 (or other scheduling information, and the first UE 115x may receive the sidelink data from the second UE 115y. In some implementations, the first UE 115x relays the sidelink data to one or more other devices such as the base station 105.

One or more aspects described herein may improve performance of a wireless communication system. For example, because channel sensing and reservation operations may be associated with a relatively large amount of power consumption, and because the first UE 115x may be associated with higher-complexity or higher-cost components or circuitry than the second UE 115y, offloading the resource reservation operation 322 from the second UE 115y to the first UE 115x may reduce power consumption by the second UE 115y.

Further, in some cases, offloading the resource reservation operation 322 from the second UE 115y to the first UE 115x may improve results of the resource reservation operation 322 (as compared to performance of the resource reservation operation 322 by the second UE 115y). For example, in some implementations, the second UE 115y may be associated with a communication bandwidth that is less than a communication bandwidth of the first UE 115x, such as if the receiver 358y has a communication bandwidth that is less than a communication bandwidth of the receiver 358x. In this case, the second UE 115y may be unable to detect one or more reservation signals transmitted at frequencies outside the communication bandwidth of the receiver 358y. As a result, offloading the resource reservation operation 322 from the second UE 115y to the first UE 115x may reduce or avoid instances of signal collisions that may occur if the second UE 115y fails to detect a reservation signal while performing the resource reservation operation 322.

FIG. 8 is a flow chart of a method 800 of operation of a UE according to some aspects of the disclosure. In some examples, the method 800 is performed by the first UE 115x. In some examples, the first UE 115x uses the processor 280x, the memory 282x, the transmitter 356x, and the receiver 358x to perform operations of the method 800. For example, the processor 280x may be configured to execute instructions stored at the memory 282x to perform one or more operations described herein, such as to initiate transmission of one or more signals (such as the SCI message 330 or the wakeup signal 382) using the transmitter 356x, to control reception of one or more signals (such as the one or more configuration messages 310, the scheduling request 384, or the sidelink communication 390) using the receiver 358x, or a combination thereof.

The method 800 includes determining scheduling information that is associated with a sidelink communication associated with a second UE, at 802. For example, the first UE 115x may determine the scheduling information 326 associated with the sidelink communication 390.

The method 800 further includes transmitting, via a sidelink control channel, a SCI message to the second UE indicating the scheduling information for use in connection with the sidelink communication, at 804. For example, the first UE 115x may transmit the SCI message 330 via the sidelink control channel 360 to the second UE 115y indicating the scheduling information 326.

FIG. 9 is a flow chart of a method 900 of operation of a UE according to some aspects of the disclosure. In some examples, the method 900 is performed by the second UE 115y. In some examples, the second UE 115y uses the processor 280y, the memory 282y, the transmitter 356y, and the receiver 358y to perform operations of the method 800. For example, the processor 280y may be configured to execute instructions stored at the memory 282y to perform one or more operations described herein, such as to control reception of one or more signals (such as the SCI message 330 or the wakeup signal 382) using the receiver 358y, to initiate transmission of one or more signals (such as the one or more configuration messages 310, the scheduling request 384, or the sidelink communication 390) using the transmitter 356y, or a combination thereof.

The method 900 includes receiving, via a sidelink control channel, an SCI message from a first UE and by a second UE, at 902. The SCI message indicates scheduling information for use in connection with the sidelink communication. For example, the second UE 115y may receive the SCI message 330 from the first UE 115x via the sidelink control channel 360, and the SCI message 330 may indicate the scheduling information 326.

The method 900 further includes performing the sidelink communication based on the scheduling information, at 904. As an illustrative example, the second UE 115y may perform the sidelink communication 390 based on the scheduling information 326.

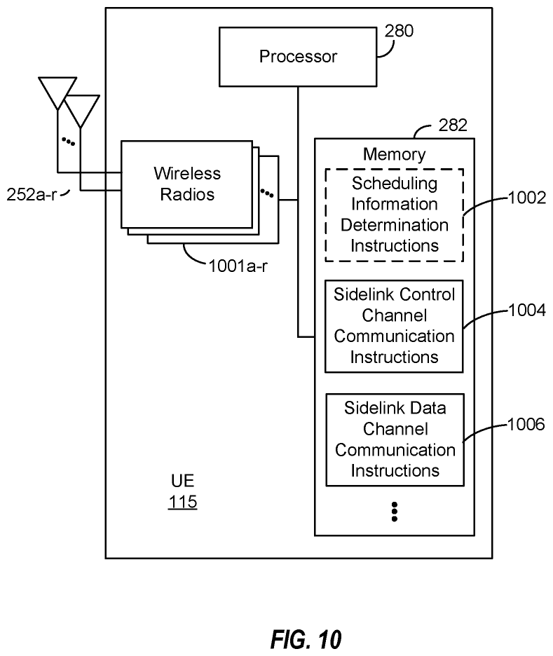

FIG. 10 is a block diagram illustrating an example of a UE 115 according to some aspects of the disclosure. In some examples, the UE 115 of FIG. 10 may correspond to any of the UEs 115x, 115y, and 115z of FIG. 3.

The UE 115 may include structure, hardware, or components described herein. For example, the UE 115 may include the processor 280, which may execute instructions stored in the memory 282. Using the processor 280, the UE 115 may transmit and receive signals via wireless radios 1001a-r and antennas 252a-r. The wireless radios 1001a-r may include one or more components or devices described herein, such as the modulator/demodulators 254a-r, the MIMO detector 256, the receive processor 258, the transmit processor 264, the TX MIMO processor 266, the transmitter 356x or the transmitter 356y, the receiver 358x or the receiver 358y, one or more other components or devices, or a combination thereof.

The memory 282 may store instructions executable by the processor 280 to initiate, perform, or control one or more operations described herein. For example, in some implementations, the memory 282 may store scheduling information determination instructions 1002 executable by the processor 280 to determine the scheduling information 326. As another example, the memory 282 may store sidelink control channel communication instructions 1004 executable by the processor 280 to transmit and receive signals via the sidelink control channel 360, such as one or more of the SCI message 330, the wakeup signal 382, or the scheduling request 384. As an additional example, in some implementations, the memory 282 may store sidelink data channel communication instructions 1006 executable by the processor 280 to perform the sidelink communication 390.

In a first aspect, a method of wireless communication performed by a first UE includes determining scheduling information that is associated with a sidelink communication associated with a second UE. The method further includes transmitting, via a sidelink control channel, a SCI message to the second UE indicating the scheduling information for use in connection with the sidelink communication.

In a second aspect alternatively or in addition to the first aspect, the method includes transmitting a wakeup signal indicating that the second UE is to transition from a first mode of operation to a second mode of operation to monitor for the SCI message during an active portion of a SCI transmission schedule.

In a third aspect alternatively or in addition to one or more of the first through second aspects, the first UE transmits the wakeup signal prior to the active portion to indicate whether the second UE is to monitor for the SCI message during the active portion.

In a fourth aspect alternatively or in addition to one or more of the first through third aspects, the first UE transmits the wakeup signal during the active portion, and the wakeup signal indicates whether the second UE is to monitor for the SCI message during one or more particular slots of the active portion.

In a fifth aspect alternatively or in addition to one or more of the first through fourth aspects, the SCI message indicates whether the second UE is to perform a BWP switching operation from a first BWP to a second BWP for the sidelink communication.

In a sixth aspect alternatively or in addition to one or more of the first through fifth aspects, the first UE transmits the SCI message using resources included in a dedicated resource pool for SCI communication between the first UE and the second UE.

In a seventh aspect alternatively or in addition to one or more of the first through sixth aspects, the first UE is associated with a first supported communication bandwidth, the second UE is associated with a second supported communication bandwidth less than the first supported communication bandwidth, and frequency resources of the dedicated resource pool are based on the second supported communication bandwidth.

In an eighth aspect alternatively or in addition to one or more of the first through seventh aspects, the method includes receiving, from a base station, one or more configuration messages indicating the dedicated resource pool.

In a ninth aspect alternatively or in addition to one or more of the first through eighth aspects, the method includes determining, by the first UE, the dedicated resource pool based at least in part on one or more of a supported communication bandwidth associated with the second UE or a common resource pool configuration message received from a base station.

In a tenth aspect alternatively or in addition to one or more of the first through ninth aspects, an apparatus for wireless communication includes a memory and a processor coupled to the memory. The memory is configured to determine, at a first UE, scheduling information that is associated with a sidelink communication associated with a second UE and to initiate transmission, via a sidelink control channel, of an SCI message to the second UE indicating the scheduling information for use in connection with the sidelink communication.

In an eleventh aspect alternatively or in addition to one or more of the first through tenth aspects, the processor is configured to receive, from a base station, one or more configuration messages indicating that the first UE is associated with the second UE, and the first UE transmits the SCI message based on receiving the one or more configuration messages.

In a twelfth aspect alternatively or in addition to one or more of the first through eleventh aspects, the processor is further configured to detect the second UE using a relay selection process or a relay reselection process and to initiate the transmission of the SCI message based on detecting the second UE using the relay selection process or the relay reselection process.

In a thirteenth aspect alternatively or in addition to one or more of the first through twelfth aspects, the processor is further configured to broadcast the SCI message to indicate presence of the first UE to one or more UEs within communication range of the first UE.

In a fourteenth aspect alternatively or in addition to one or more of the first through thirteenth aspects, the processor is further configured to initiate the transmission of the SCI message during an SCI monitoring occasion that is associated with the first UE and the second UE, and the SCI monitoring occasion is associated with time resources and frequency resources that are dedicated to the first UE and the second UE.

In a fifteenth aspect alternatively or in addition to one or more of the first through fourteenth aspects, the second UE is associated with a supported communication bandwidth, and a frequency hopping pattern associated with the frequency resources is associated with a frequency range that exceeds the supported communication bandwidth.

In a sixteenth aspect alternatively or in addition to one or more of the first through fifteenth aspects, the time resources correspond to a subset of a dedicated resource pool for communication between the first UE and the second UE.

In a seventeenth aspect alternatively or in addition to one or more of the first through sixteenth aspects, the scheduling information indicates one or more of a DRX parameter associated with the second UE, a wakeup parameter associated with the second UE, a BWP switching parameter associated with the second UE, transmission scheduling information associated with the second UE, or reception scheduling information associated with the second UE.

In an eighteenth aspect alternatively or in addition to one or more of the first through seventeenth aspects, the apparatus includes a receiver configured to receive, from the second UE, a scheduling request for resources associated with the sidelink communication, and the first UE transmits the SCI message based on receiving the scheduling request.

In a nineteenth aspect alternatively or in addition to one or more of the first through eighteenth aspects, the processor is further configured to receive, from a base station in connection with a mode one sidelink resource allocation operation, one or more configuration messages indicating resources associated with the sidelink communication, and the scheduling information indicates the resources.

In a twentieth aspect alternatively or in addition to one or more of the first through nineteenth aspects, the processor is further configured to perform a resource reservation operation that includes sensing one or more wireless communication channels in connection with a mode two sidelink resource allocation operation and to determine, based on a result the resource reservation operation, availability of resources for the sidelink communication, and the scheduling information indicates the resources.

In a twenty-first aspect alternatively or in addition to one or more of the first through twentieth aspects, the processor is further configured to initiate the transmission of the SCI message via the sidelink control channel based on an SCI transmission schedule and to transmit an indication of the SCI transmission schedule to the second UE via a sidelink data channel.

In a twenty-second aspect alternatively or in addition to one or more of the first through twenty-first aspects, the SCI transmission schedule indicates a first plurality of slots during which the second UE is to monitor the sidelink control channel for SCI messages including the SCI message, and the SCI transmission schedule further indicates a second plurality of slots during which the second UE is to avoid monitoring the sidelink control channel for the SCI messages.

In a twenty-third aspect alternatively or in addition to one or more of the first through twenty-second aspects, the SCI message indicates that the sidelink communication is to include transmitting data by one of the second UE and a third UE to the other of the second UE and the third UE.

In a twenty-fourth aspect alternatively or in addition to one or more of the first through twenty-third aspects, the processor is further configured to initiate the transmission to the second UE and to the third UE, and the SCI message identifies the second UE as a transmitter of the sidelink communication and further identifies the third UE as a receiver of the sidelink communication.

In a twenty-fifth aspect alternatively or in addition to one or more of the first through twenty-fourth aspects, the SCI message corresponds to a first SCI message that identifies the second UE as a transmitter of the sidelink communication, and the processor is further configured to initiate transmission of a second SCI message that includes a wakeup signal to the third UE prior to performing the sidelink communication.

In a twenty-sixth aspect alternatively or in addition to one or more of the first through twenty-fifth aspects, the SCI message indicates that the sidelink communication is to include transmitting data by one of the first UE and the second UE to the other of the first UE and the second UE.

In a twenty-seventh aspect alternatively or in addition to one or more of the first through twenty-sixth aspects, the SCI message indicates that the sidelink communication is to include relaying downlink data from a base station to the second UE and by relaying uplink data from the second UE to the base station.

In a twenty-eighth aspect alternatively or in addition to one or more of the first through twenty-seventh aspects, the SCI message indicates that the sidelink communication is to include relaying uplink data from the second UE to a base station, and the second UE receives downlink data directly from the base station.

In a twenty-ninth aspect alternatively or in addition to one or more of the first through twenty-eighth aspects, a non-transitory computer-readable medium stores instructions executable by a processor to initiate, perform, or control operations. The operations include determining, at a first UE, scheduling information that is associated with a sidelink communication associated with a second UE. The operations further include transmitting, via a sidelink control channel, an SCI message to the second UE indicating the scheduling information for use in connection with the sidelink communication.

In a thirtieth aspect alternatively or in addition to one or more of the first through twenty-ninth aspects, an apparatus for wireless communication includes means for determining, at a first UE, scheduling information that is associated with a sidelink communication associated with a second UE. The apparatus further includes means for transmitting, via a sidelink control channel, an SCI message to the second UE indicating the scheduling information for use in connection with the sidelink communication.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and operations described herein may be implemented as electronic hardware, computer software, or combinations of both. To illustrate, various illustrative components, blocks, modules, circuits, and steps have been described above generally in terms of their functionality. Whether such functionality is implemented as hardware or software may depend upon the particular application and design of the overall system. Skilled artisans may implement the described functionality in varying ways for each particular application, but such implementation decisions should not be interpreted as causing a departure from the scope of the disclosure. Skilled artisans will also readily recognize that the order or combination of components, methods, or interactions that are described herein may be combined or performed in ways other than those illustrated and described herein.

The hardware and devices that may be used to implement the various illustrative logics, logical blocks, modules, and circuits described herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, one or more functions described may be implemented in hardware, digital electronic circuitry, computer software, firmware, including the structures disclosed in this specification and their structural equivalents thereof, or in any combination thereof. Implementations of the subject matter described herein also may be implemented as one or more computer programs, that is one or more modules of computer program instructions, encoded on a computer storage media for execution by, or to control the operation of, a data processing apparatus.

If implemented in software, the functions may be stored on or transmitted over as one or more instructions or code on a computer-readable medium. The operations of a method or process disclosed herein may be implemented in a processor-executable software module which may reside on a computer-readable medium. Computer-readable media includes computer storage media. A storage media may be any available media that may be accessed by a computer. For example, computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or process may reside as one or any combination or set of codes and instructions on a machine readable medium and computer-readable medium, which may be incorporated into a computer program product.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a first user equipment (UE), the method comprising:
determining scheduling information that is associated with a sidelink communication associated with a second UE; and
transmitting, via a sidelink control channel, a sidelink control information (SCI) message to the second UE indicating the scheduling information for use in connection with the sidelink communication.

2. The method of claim 1, further comprising transmitting a wakeup signal indicating that the second UE is to transition from a first mode of operation to a second mode of operation to monitor for the SCI message during an active portion of a SCI transmission schedule.

3. The method of claim 2, wherein the first UE transmits the wakeup signal prior to the active portion to indicate whether the second UE is to monitor for the SCI message during the active portion.

4. The method of claim 2, wherein the first UE transmits the wakeup signal during the active portion, and wherein the wakeup signal indicates whether the second UE is to monitor for the SCI message during one or more particular slots of the active portion.

5. The method of claim 1, wherein the SCI message indicates whether the second UE is to perform a bandwidth part (BWP) switching operation from a first BWP to a second BWP for the sidelink communication.

6. The method of claim 1, wherein the first UE transmits the SCI message using resources included in a dedicated resource pool for SCI communication between the first UE and the second UE.

7. The method of claim 6, wherein the first UE is associated with a first supported communication bandwidth, wherein the second UE is associated with a second supported communication bandwidth less than the first supported communication bandwidth, and wherein frequency resources of the dedicated resource pool are based on the second supported communication bandwidth.

8. The method of claim 6, further comprising receiving, from a base station, one or more configuration messages indicating the dedicated resource pool.

9. The method of claim 6, further comprising determining, by the first UE, the dedicated resource pool based at least in part on one or more of a supported communication bandwidth associated with the second UE or a common resource pool configuration message received from a base station.

10. An apparatus for wireless communication, the apparatus comprising:
a memory; and
a processor coupled to the memory and configured to determine, at a first user equipment (UE), scheduling information that is associated with a sidelink communication associated with a second UE and to initiate transmission, via a sidelink control channel, of a sidelink control information (SCI) message to the second UE indicating the scheduling information for use in connection with the sidelink communication.

11. The apparatus of claim 10, wherein the processor is configured to receive, from a base station, one or more configuration messages indicating that the first UE is associated with the second UE, wherein the first UE transmits the SCI message based on receiving the one or more configuration messages.

12. The apparatus of claim 10, wherein the processor is further configured to detect the second UE using a relay selection process or a relay reselection process and to initiate the transmission of the SCI message based on detecting the second UE using the relay selection process or the relay reselection process.

13. The apparatus of claim 10, wherein the processor is further configured to broadcast the SCI message to indicate presence of the first UE to one or more UEs within communication range of the first UE.

14. The apparatus of claim 10, wherein the processor is further configured to initiate the transmission of the SCI message during an SCI monitoring occasion that is associated with the first UE and the second UE, and wherein the SCI monitoring occasion is associated with time resources and frequency resources that are dedicated to the first UE and the second UE.

15. The apparatus of claim 14, wherein the second UE is associated with a supported communication bandwidth, and wherein a frequency hopping pattern associated with the frequency resources is associated with a frequency range that exceeds the supported communication bandwidth.

16. The apparatus of claim 14, wherein the time resources correspond to a subset of a dedicated resource pool for communication between the first UE and the second UE.

17. The apparatus of claim 10, wherein the scheduling information indicates one or more of a discontinuous reception (DRX) parameter associated with the second UE, a wakeup parameter associated with the second UE, a bandwidth part (BWP) switching parameter associated with the second UE, transmission scheduling information associated with the second UE, or reception scheduling information associated with the second UE.

18. The apparatus of claim 10, further comprising a receiver configured to receive, from the second UE, a scheduling request for resources associated with the sidelink communication, wherein the first UE transmits the SCI message based on receiving the scheduling request.

19. The apparatus of claim 10, wherein the processor is further configured to receive, from a base station in connection with a mode one sidelink resource allocation operation, one or more configuration messages indicating resources associated with the sidelink communication, wherein the scheduling information indicates the resources.

20. The apparatus of claim 10, wherein the processor is further configured to perform a resource reservation operation that includes sensing one or more wireless communication channels in connection with a mode two sidelink resource allocation operation and to determine, based on a result the resource reservation operation, availability of resources for the sidelink communication, and wherein the scheduling information indicates the resources.

21. The apparatus of claim 10, wherein the processor is further configured to initiate the transmission of the SCI message via the sidelink control channel based on an SCI transmission schedule and to transmit an indication of the SCI transmission schedule to the second UE via a sidelink data channel.

22. The apparatus of claim 21, wherein the SCI transmission schedule indicates a first plurality of slots during which the second UE is to monitor the sidelink control channel for SCI messages including the SCI message, and wherein the SCI transmission schedule further indicates a second plurality of slots during which the second UE is to avoid monitoring the sidelink control channel for the SCI messages.

23. The apparatus of claim 10, wherein the SCI message indicates that the sidelink communication is to include transmitting data by one of the second UE and a third UE to the other of the second UE and the third UE.

24. The apparatus of claim 23, wherein the processor is further configured to initiate the transmission to the second UE and to the third UE, and wherein the SCI message identifies the second UE as a transmitter of the sidelink communication and further identifies the third UE as a receiver of the sidelink communication.

25. The apparatus of claim 23, wherein the SCI message corresponds to a first SCI message that identifies the second UE as a transmitter of the sidelink communication, and wherein the processor is further configured to initiate transmission of a second SCI message that includes a wakeup signal to the third UE prior to performing the sidelink communication.

26. The apparatus of claim 10, wherein the SCI message indicates that the sidelink communication is to include transmitting data by one of the first UE and the second UE to the other of the first UE and the second UE.

27. The apparatus of claim 26, wherein the SCI message indicates that the sidelink communication is to include relaying downlink data from a base station to the second UE and by relaying uplink data from the second UE to the base station.

28. The apparatus of claim 26, wherein the SCI message indicates that the sidelink communication is to include relaying uplink data from the second UE to a base station, and wherein the second UE receives downlink data directly from the base station.

29. A non-transitory computer-readable medium storing instructions executable by a processor to initiate, perform, or control operations, the operations comprising:
determining, by a first user equipment (UE), scheduling information that is associated with a sidelink communication associated with a second UE; and
transmitting, via a sidelink control channel, a sidelink control information (SCI) message to the second UE indicating the scheduling information for use in connection with the sidelink communication.

30. An apparatus for wireless communication, the apparatus comprising:
means for determining, at a first user equipment (UE), scheduling information that is associated with a sidelink communication associated with a second UE; and
means for transmitting, via a sidelink control channel, a sidelink control information (SCI) message to the second UE indicating the scheduling information for use in connection with the sidelink communication.
